(19) United States
(12) Patent Application Publication
(10) Pub. No.: US 2024/0304126 A1
(43) Pub. Date: Sep. 12, 2024

(54) DISPLAY DRIVING DEVICE AND DISPLAY DEVICE

(71) Applicant: LAPIS Technology Co., Ltd., Yokohama (JP)

(72) Inventor: Keita WATANABE, Yokohama (JP)

(73) Assignee: LAPIS Technology Co., Ltd., Yokohama (JP)

(21) Appl. No.: 18/595,359

(22) Filed: Mar. 4, 2024

(30) Foreign Application Priority Data
Mar. 9, 2023 (JP) 2023-036982

(51) Int. Cl. G09G 3/00; G09G 3/36

(52) U.S. Cl. CPC G09G 3/006; G09G 3/36; G09G 3/3685; G09G 2310/0289; G09G 2310/0291; G09G 2330/04; G09G 2330/08; G09G 2330/12

(57) ABSTRACT

Disclosed are a display driving device and a display device that are capable of operating normally even when noise occurs. The display driving device includes: a logic circuit including a register configured to store a register value, a backup memory configured to store the register value stored in the register, a noise detector configured to detect noise that occurs in the logic circuit, and a change part configured to change the register value stored in the register to the register value stored in the backup memory in response to noise being detected by the noise detector.

### CROSS-REFERENCE TO RELATED APPLICATION

This application claims the priority benefits of Japanese application no. 2023-036982, filed on Mar. 9, 2023. The entirety of the above-mentioned patent application is hereby incorporated by reference herein and made a part of this specification.

### BACKGROUND

### Technical Field

The disclosure relates to a display driving device and a display device.

### Description of Related Art

Patent Document 1 (Japanese Patent Application Laid-Open No. 2009-145492) describes a display driving device for driving a liquid crystal display device.

When power supply noise resulting from, for example, ESD (Electro-Static Discharge) occurs in a display driving device for driving a display device such as a liquid crystal display device, there is a possibility that the register value stored in the register inside the display driving device may change, making it no longer possible to perform the normal operation.

The disclosure provides a display driving device and a display device that are capable of operating normally even when noise occurs.

### SUMMARY

A display driving device according to an embodiment of the disclosure includes: a logic circuit including a register configured to store a register value; a backup memory configured to store the register value stored in the register; a noise detector configured to detect noise that occurs in the logic circuit; and a change part configured to change the register value stored in the register to the register value stored in the backup memory in response to noise being detected by the noise detector.

A display device according to an embodiment of the disclosure includes: the display driving device according to the disclosure; and a display panel to which a display signal voltage is supplied from the display driving device via a signal line.

### BRIEF DESCRIPTION OF THE DRAWINGS

FIG. 1 is a schematic configuration diagram showing the overall configuration of the liquid crystal display device according to an embodiment of the disclosure.

FIG. 2 is a block diagram showing the schematic configuration of the source driver.

FIG. 3 is a schematic configuration diagram of the register in the data register without the backup memory.

FIG. 4 is a detailed configuration diagram of the periphery of the register in the data register without the backup memory.

FIG. 5 is a timing chart of the operation in the data register when noise occurs on the ground line in the data register without the backup memory.

FIG. 6 is a schematic configuration diagram of the register in the data register according to the embodiment.

FIG. 7 is a detailed configuration diagram of the periphery of the register in the data register according to the embodiment.

FIG. 8 is a timing chart of the operation in the data register when noise occurs on the ground line in the data register according to the embodiment.

FIG. 9 is a flowchart showing the operating situation when noise occurs on the ground line in the data register without the backup memory.

FIG. 10 is a flowchart showing the operating situation when noise occurs on the ground line in the data register according to the embodiment.

### DESCRIPTION OF THE EMBODIMENTS

According to the disclosure, it is possible to provide a display driving device and a display device that are capable of operating normally even when noise occurs.

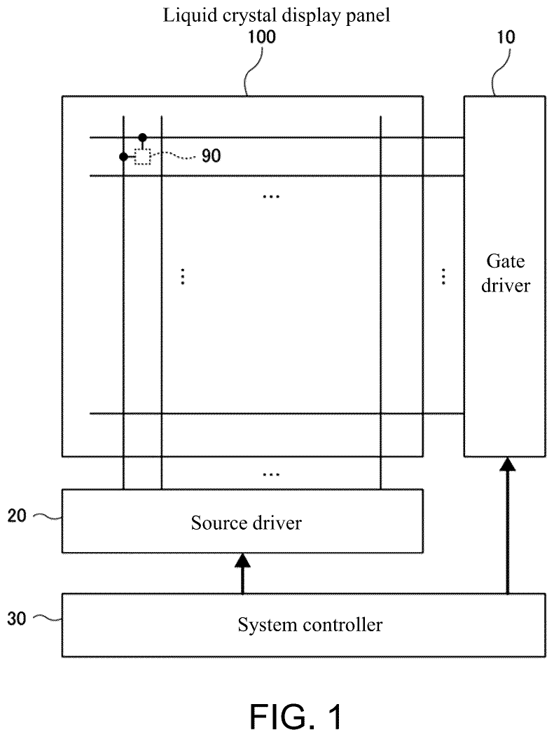

Embodiments of the disclosure will be described hereinafter based on the drawings. FIG. 1 is a schematic configuration diagram showing the overall configuration of a liquid crystal display device according to an embodiment of the disclosure.

As shown in FIG. 1, the liquid crystal display device according to this embodiment includes a liquid crystal display panel 100, a gate driver 10, a source driver 20, and a system controller 30. The liquid crystal display device is an example of the display device in the technology of the disclosure. Further, the source driver 20 is an example of the display driving device in the technology of the disclosure.

The liquid crystal display panel 100 includes liquid crystal pixels 90 arranged in a matrix, a plurality of scanning lines extending in the row direction of the matrix, and a plurality of signal lines extending in the column direction of the matrix.

The gate driver 10 sequentially applies a scanning signal to each scanning line to set the scanning line to a selected state based on a vertical control signal supplied from the system controller 30, which will be described later.

The source driver 20 supplies a display signal voltage corresponding to display data given from the system controller 30 to each liquid crystal pixel 90 set to a selected state by the gate driver 10 via a signal line based on a horizontal control signal supplied from the system controller 30, which will be described later.

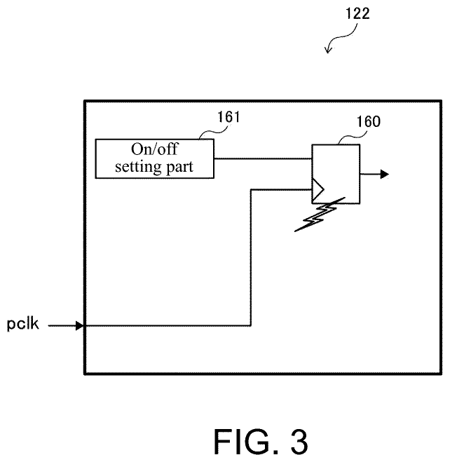

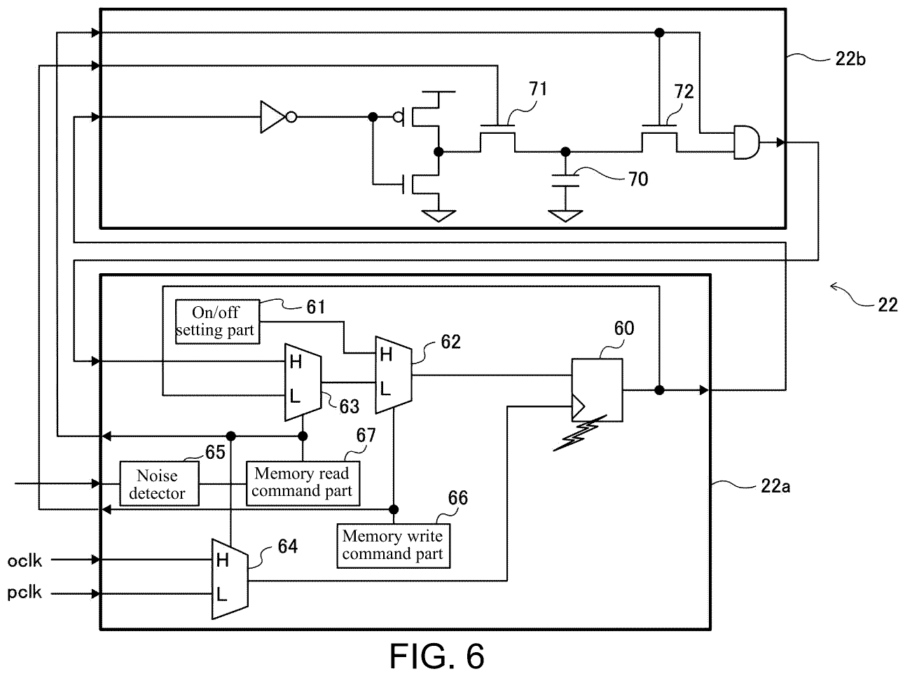

The system controller 30 generates the vertical control signal and the horizontal control signal based on a system clock pclk (see FIG. 3 and FIG. 6) and respectively supplies the vertical control signal and the horizontal control signal to the gate driver 10 and the source driver 20, thereby applying the display signal voltage to the liquid crystal pixel 90 at a predetermined timing to control the liquid crystal display panel 100 to display desired image information.

That is, the system controller 30 generates various control signals for displaying desired image information on the liquid crystal display panel 100 based on display data supplied from the outside, and outputs the control signals to the gate driver 10 and the source driver 20.

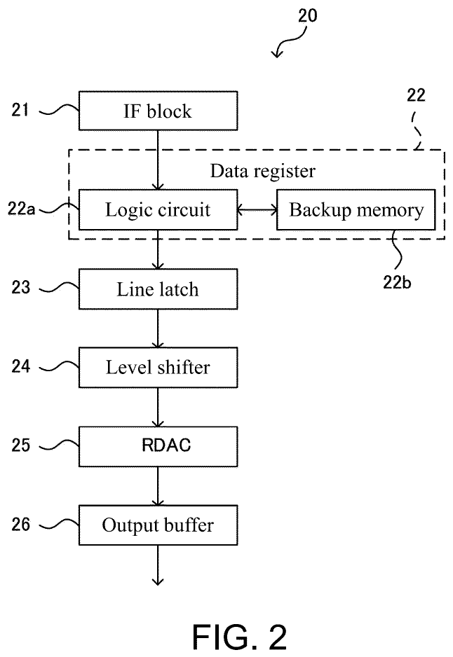

FIG. 2 is a block diagram showing the schematic configuration of the source driver 20. As shown in FIG. 2, the source driver 20 includes an interface block (hereinafter referred to as IF block) 21, a data register 22, a line latch 23, a level shifter 24, an RDAC (Register string Digital Analog Converter) 25, and an output buffer 26.

The IF block 21 starts with a shift register start signal supplied as a horizontal control signal from the system controller 30, sequentially performs a shift operation using a clock signal also supplied as a horizontal control signal, and sequentially outputs display data supplied from the system controller 30.

The data register 22 takes in the display data supplied from the IF block 21.

The line latch 23 takes in and holds one line of display data from among the display data captured by the data register 22 all at once.

The level shifter 24 level-shifts the signal level of the display data held in the line latch 23 from the logic voltage level to the power supply voltage level of the source driver.

The RDAC 25 is a digital/analog converter for converting the display data composed of a digital RGB signal and level-shifted by the level shifter 24 into an analog RGB signal based on the horizontal control signal, etc. supplied from the system controller 30, and outputting the analog RGB signal.

The output buffer 26 amplifies the output of the RDAC 25 and outputs the amplified output to the liquid crystal display panel 100 as a display signal voltage.

In the source driver 20 as described above, when power supply noise occurs due to ESD or the like, for example, the register value stored in the register inside the display driving device may change, making it no longer possible to perform the normal operation.

In order to solve such problems, the data register 22 of the source driver 20 in the liquid crystal display device of this embodiment includes a logic circuit part 22a that has a register for storing the register value, a backup memory 22b that stores the register value stored in the register, a noise detector 65 that detects noise generated in the logic circuit part 22a, and a memory read command part (change part) 67 that changes the register value stored in the register to the register value stored in the backup memory 22b when noise is detected by the noise detector 65.

The configuration of the backup memory 22b in the data register 22 and the operation of the backup memory 22b will be described in detail below. It should be noted that the register value stored in the backup memory 22b may be the register value of any register. Here, described as an example is a case where the backup memory 22b is combined with an error detection on/off setting register for image data in the data register 22.

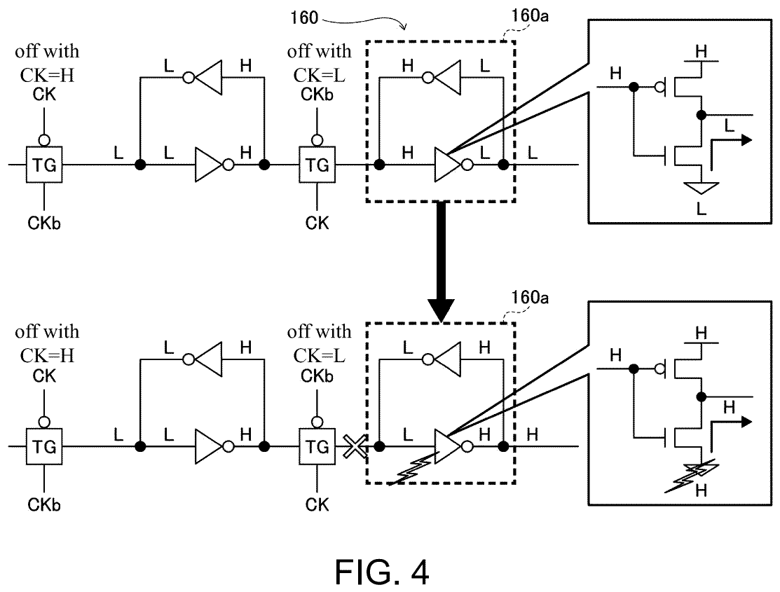

First, the operation when the data register 22 does not include the backup memory 22b will be described. FIG. 3 is a schematic configuration diagram of the register in the data register 122 without the backup memory. FIG. 4 is a detailed configuration diagram of the periphery of the register in the data register 122.

As shown in FIG. 3, the error detection on/off setting register 160 for image data in the data register 122 stores the setting value input from an on/off setting part 161 as a register value in synchronization with the system clock pclk supplied from the system controller 30.

In detail, the error detection on/off setting register 160 includes a CMOS (Complementary Metal-Oxide-Semiconductor) 160a, as shown in FIG. 4. This CMOS 160a holds the high level or low level register value input from the previous stage, but when noise in the direction of the power supply voltage (for example, power supply noise due to ESD) occurs on the ground line while the CMOS 160a holds low level, for example, the level of the signal held by the CMOS 160a may be inverted from low level to high level.

When such a level inversion occurs in the error detection on/off setting register 160, the inverted level is held permanently until the system clock pclk is restarted, which causes a deadlock.

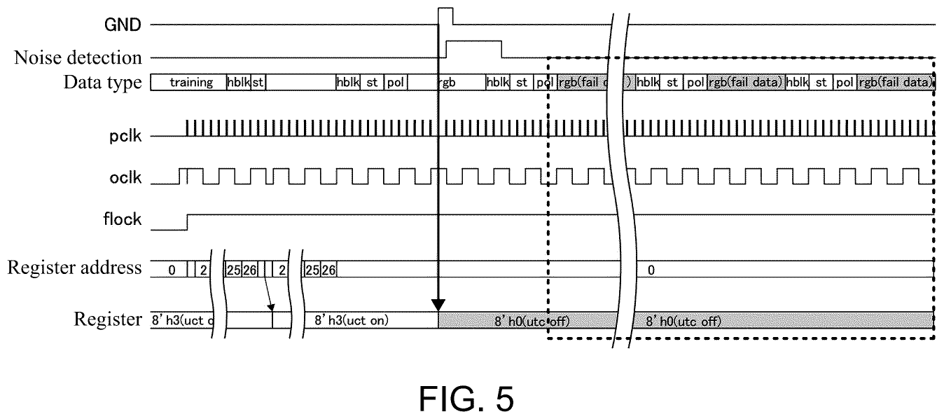

FIG. 5 is a timing chart of the operation in the data register 122 when noise occurs on the ground line.

In FIG. 5, GND indicates the signal state of the ground line. In the normal state where no noise occurs, the ground line is in the low level state. Noise detection indicates the state of detecting noise that occurs on the ground line. In noise detection, low level indicates a state where no noise is detected, and high level indicates a state where noise is detected. Data type indicates the type of the display data supplied from the system controller 30. There are multiple types in data type, and among the multiple types, “rgb (fail data)” indicates abnormal data.

pclk indicates the signal state of the system clock pclk supplied from the system controller 30. oclk indicates the signal state of the internal clock of the data register 122. flock indicates the data holding state of the error detection on/off setting register 160. In flock, low level indicates a state where data is not held, and high level indicates a state where data is held.

Register address periodically sets the address of the register to be set. Register indicates the register value that is held by the error detection on/off setting register 160.

As shown in FIG. 5, when noise occurs on the ground line, the register value of the error detection on/off setting register 160 changes from “8h′3 (error detection on)” to “8h′0 (error detection off)”. In this state, if the system clock pclk is operating normally, the error detection on/off setting register 160 deadlocks, and becomes unable to detect errors in image data permanently from then on.

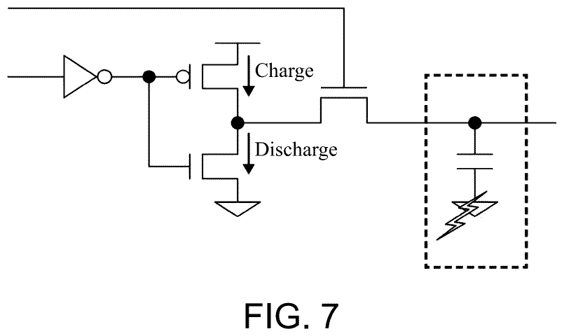

Next, the operation when the data register 22 includes the backup memory 22b will be described. FIG. 6 is a schematic configuration diagram of the register in the data register 22 including the backup memory 22b. FIG. 7 is a detailed configuration diagram of the periphery of the backup memory 22b.

As shown in FIG. 6, the logic circuit part 22a of the data register 22 includes an error detection on/off setting register 60, an on/off setting part 61, selectors 62, 63, and 64, a noise detector 65, a memory write command part 66, a memory read command part 67, etc.

The error detection on/off setting register 60 has the same configuration as the error detection on/off setting register 160 described above. The on/off setting part 61 sets the register value for the error detection on/off setting register 60. The selectors 62, 63, and 64 output the signal of one system among input signals of two systems based on an instruction input from the outside.

The noise detector 65 detects noise superimposed on the ground line of the data register 22. The memory write command part 66 performs control to write the register value stored in the error detection on/off setting register 60 to the backup memory 22b, which will be described later. The memory read command part 67 performs control to read the register value stored in the backup memory 22b, which will be described later, from the backup memory 22b, and write the register value to the error detection on/off setting register 60. The memory read command part 67 corresponds to the change part in the technology of the disclosure.

Further, the backup memory 22b of the data register 22 includes a capacitor 70, a switching transistor 71 for writing, a switching transistor 72 for reading, etc.

The capacitor 70 stores the register value output from the error detection on/off setting register 60. As shown in FIG. 7, by storing the register value using the capacitor 70, even if noise in the direction of the power supply voltage occurs on the ground line, the register value stored in the capacitor does not change.

The switching transistor 71 switches the on/off state of the switch based on control from the memory write command part 66. When the switching transistor 71 is in the on state, the register value is written to the capacitor 70.

The switching transistor 72 switches the on/off state of the switch based on control from the memory read command part 67. When the switching transistor 72 is in the on state, the register value stored in the capacitor 70 is output from the backup memory 22b.

The error detection on/off setting register 60 of the data register 22 normally stores the setting value input from the on/off setting part 61 as a register value in synchronization with the system clock pclk supplied from the system controller 30.

Further, the output of the error detection on/off setting register 60 is connected to the backup memory 22b, and the memory write command part 66 turns on the switching transistor 71 and stores the register value output from the error detection on/off setting register 60 in the capacitor 70.

When power supply noise occurs in the data register 22, there is a possibility that the register value stored in the error detection on/off setting register 60 may change.

However, in the data register 22 of this embodiment, when the noise detector 65 detects noise, the noise detector 65 notifies the memory read command part 67 of noise detection.

Upon receiving the notification of noise detection, the memory read command part 67 turns on the switching transistor 72, and outputs the register value stored in the capacitor 70 from the backup memory 22b. Furthermore, the memory read command part 67 switches the output of the selector 64 from the system clock pclk to the internal clock oclk of the data register 22.

The register value output from the backup memory 22b is input to the logic circuit part 22a, and the register value of the error detection on/off setting register 60 is rewritten to the input register value.

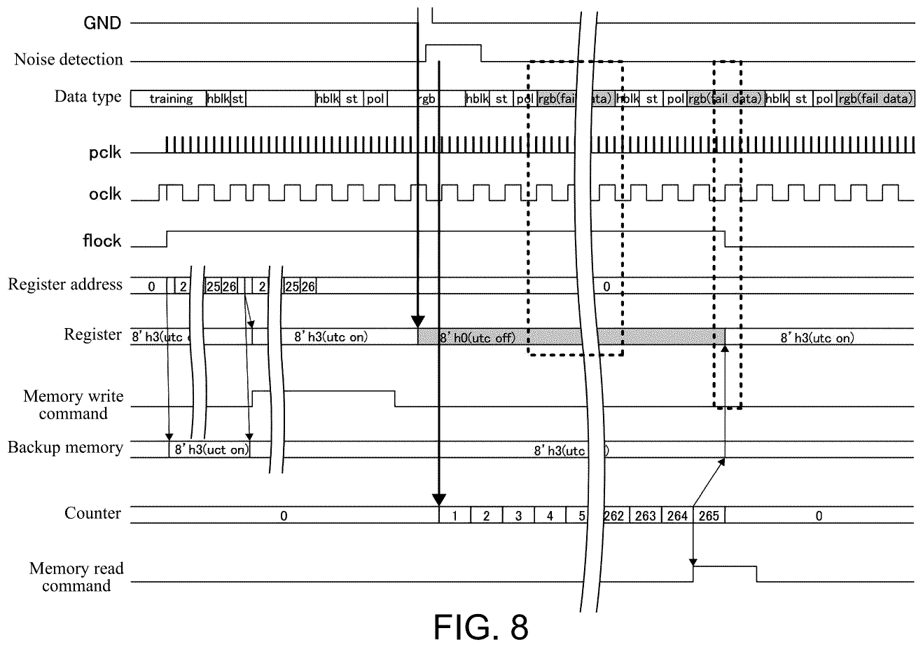

FIG. 8 is a timing chart of the operation in the data register 22 when noise occurs on the ground line.

In FIG. 8, GND indicates the signal state of the ground line. In the normal state where no noise occurs, the ground line is in the low level state. Noise detection indicates the state of detecting noise that occurs on the ground line by the noise detector 65. In noise detection, low level indicates a state where no noise is detected, and high level indicates a state where noise is detected. Data type indicates the type of the display data supplied from the system controller 30. There are multiple types in data type, and among the multiple types, “rgb (fail data)” indicates abnormal data.

pclk indicates the signal state of the system clock pclk supplied from the system controller 30. oclk indicates the signal state of the internal clock of the data register 22. flock indicates the data holding state of the error detection on/off setting register 60. In flock, low level indicates a state where data is not held, and high level indicates a state where data is held.

Register address periodically sets the address of the register to be set. Register indicates the register value that is held by the error detection on/off setting register 60.

Memory write command indicates the signal state of the memory write command output from the memory write command part 66. The memory write command corresponds to storing the register value in the error detection on/off setting register 60, and is a signal for transmitting a command to store the register value output from the error detection on/off setting register 60 in the backup memory 22b. In memory write command, low level indicates a state where the memory write command is not output, and high level indicates a state where the memory write command is output.

Backup memory indicates the register value that is stored in the backup memory 22b. Counter counts up from 0 to 265 based on an external instruction.

Memory read command indicates the signal state of the memory read command output from the memory read command part 67. The memory read command is a signal for transmitting a command to output the register value stored in the backup memory 22b from the backup memory 22b and switch the output of the selector 64 from the system clock pclk to the internal clock oclk of the data register 22. In memory read command, low level indicates a state where the memory read command is not output, and high level indicates a state where the memory read command is output.

As shown in FIG. 8, when noise occurs on the ground line, the register value of the error detection on/off setting register 160 changes from “8h′3 (error detection on)” to “8h′0 (error detection off)”, making it impossible to detect errors of the image data.

However, in the data register 22 of this embodiment, when the noise detector 65 detects noise, the noise detector 65 notifies the memory read command part 67 of the noise detection based on the value of the counter. As an example of the specific processing, when the noise detection performed by the noise detector 65 reaches high level, the noise detector 65 activates the counter to start counting up, notifies the memory read command part 67 at the time when the value of the counter reaches the set value, and causes the memory read command to be output from the memory read command part 67.

As a result, the register value “8h′3 (error detection on)” stored in the backup memory 22b is written to the error detection on/off setting register 60, and the error detection for image data is restarted.

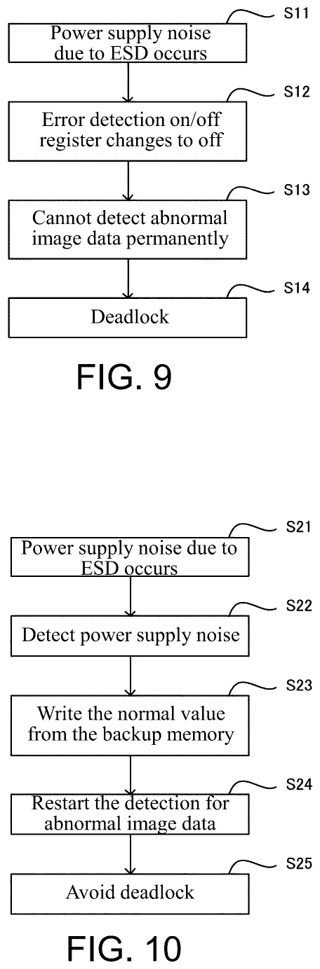

As described above, in the data register 122 without the backup memory, as shown in FIG. 9, when power supply noise due to ESD or the like occurs (step S11), the register value of the error detection on/off setting register 160 changes to a value indicating off (step S12). As a result, image data cannot be normally transmitted from the IF block 21 to the data register 22.

Further, when the register value of the error detection on/off setting register 60 changes to off due to power supply noise, abnormal image data cannot be detected permanently (step S13), and a deadlock occurs in the error detection on/off setting register 160 (step S14).

In contrast thereto, in the data register 22 of this embodiment, as shown in FIG. 10, even when power supply noise due to ESD or the like occurs and the register value of the error detection on/off setting register 60 changes to a value indicating off (step S21), the noise is detected by the noise detector 65 (step S22), and the register value stored in the backup memory 22b is written to the error detection on/off setting register 60 (step S23).

As a result, the error detection for image data is restarted (step S24), and a deadlock is avoided (step S25).

The written contents and illustrated contents described above are detailed descriptions of the parts related to the technology of the disclosure, and are merely an example of the technology of the disclosure. For example, the above descriptions regarding the configuration, function, operation, and effect are descriptions regarding an example of the configuration, function, operation, and effect of the parts related to the technology of the disclosure. Therefore, it goes without saying that unnecessary parts may be deleted, new elements may be added, or replaced with respect to the written contents and illustrated contents shown above within the scope of the technology of the disclosure. In addition, in order to avoid confusion and facilitate understanding of the parts related to the technology of the disclosure, descriptions regarding common technical knowledge or the like that does not require particular explanation to enable implementation of the technology of the disclosure are omitted from the written contents and illustrated contents described above.

What is claimed is:

1. A display driving device, comprising:
a logic circuit comprising a register configured to store a register value;
a backup memory configured to store the register value stored in the register;
a noise detector configured to detect noise that occurs in the logic circuit; and
a change part configured to change the register value stored in the register to the register value stored in the backup memory in response to noise being detected by the noise detector.

2. The display driving device according to claim 1, wherein the noise detector notifies the change part of detection of noise based on a value of a counter in response to noise being detected by the noise detector.

3. The display driving device according to claim 1, wherein the backup memory comprises a capacitor.

4. The display driving device according to claim 2, wherein the backup memory comprises a capacitor.

5. The display driving device according to claim 1, wherein the register is a register configured to store information indicating an on or off setting state of a function.

6. The display driving device according to claim 2, wherein the register is a register configured to store information indicating an on or off setting state of a function.

7. A display device, comprising:
the display driving device according to claim 1; and
a display panel to which a display signal voltage is supplied from the display driving device via a signal line.
